(19) United States
(12) Patent Application Publication
(10) Pub. No.: US 2023/0152578 A1
(43) Pub. Date: May 18, 2023

(54) MULTI-VIEW EYE TRACKING SYSTEM WITH A HOLOGRAPHIC OPTICAL ELEMENT COMBINER

(71) Applicant: META PLATFORMS TECHNOLOGIES, LLC, Menlo Park, CA (US)

(72) Inventors: Changwon JANG, Seattle, WA (US); Olivier MERCIER, Redmond, WA (US); Gregory Olegovic ANDREEV, Kirkland, WA (US); Gang LI, Bothell, WA (US); Liliana Ruiz DIAZ, Redmond, WA (US)

(21) Appl. No.: 17/526,359

(22) Filed: Nov. 15, 2021

(51) Int. Cl. G02B 27/00; G02B 5/32; H04N 13/344; H04N 13/383; H04N 9/31

(52) U.S. Cl. CPC G02B 27/0093; G02B 5/32; H04N 13/344; H04N 13/383; H04N 9/3173

(57) ABSTRACT

A method includes projecting, with a holographic optical element, a first view of an eye toward an imaging device, and projecting, with the holographic optical element, a second view of the eye, distinct from the first view of the eye, toward the imaging device so that the first view and the second view of the eye are concurrently received by the imaging device. An eye tracking device for performing the method, a holographic optical element used for the method, and a method of making the holographic optical element are also disclosed.

### TECHNICAL FIELD

This relates generally to holographic optical elements, and more specifically to holographic optical elements used in eye tracking devices for head-mounted display devices.

### BACKGROUND

Head-mounted display devices (also called herein head-mounted displays or headsets) are gaining popularity as means for providing visual information to a user. For example, the head-mounted display devices are used for virtual reality and augmented reality operations.

Head-mounted displays often require eye tracking. For example, the content displayed by a head-mounted display needs to be updated based on a gaze direction of a user, which requires eye-tracking systems for determining the position of the pupil of the eye. Thus, errors and delays in eye tracking may affect the user experience with the head-mounted displays.

### SUMMARY

Accordingly, there is a need for head-mounted displays with accurate eye tracking capabilities, thereby enhancing the user's virtual-reality and/or augmented reality experience.

One approach to track movements of an eye is to illuminate a surface of the eye, and detect reflections of the illuminated patterns off the surface of the eye (e.g., glints). However, eye tracking with such illumination has challenges, as various structures around the eye (e.g., eye lids, eye lashes, etc.) can block the illumination from reaching the surface of the eye or occlude the reflections of the illuminated patterns off the surface of the eye, which in turn reduce the accuracy in eye tracking. Even for other methods of tracking movements of an eye (e.g., using pupil tracking) that may not require separate illumination of the eye, the occlusion of a view of the eye may reduce the accuracy in eye tracking. Therefore, there is a need for eye-tracking systems that can track the position of an eye with reduced occlusion.

The above deficiencies and other problems associated with conventional eye-tracking systems are reduced or eliminated by the disclosed methods and systems.

In accordance with some embodiments, a method includes projecting, with a holographic optical element, a first view of an eye toward an imaging device; and projecting, with the holographic optical element, a second view of the eye, distinct from the first view of the eye, toward the imaging device so that the first view and the second view of the eye are concurrently received by the imaging device.

In accordance with some embodiments, an eye tracking device includes an imaging device; and a holographic optical element positioned relative to the imaging device for projecting a first view of a target area toward the imaging device and projecting a second view of the eye, distinct from the first view of the eye, toward the imaging device so that the first view and the second view of the eye are concurrently received by the imaging device.

In accordance with some embodiments, a head-mounted display device includes any eye tracking device described herein.

In accordance with some embodiments, a holographic optical element is configured for projecting a first view of a target area toward an imaging device and projecting a second view of the target area, distinct from the first view of the target area, toward the imaging device so that the first view and the second view of the target area are concurrently received by the imaging device.

In accordance with some embodiments, a method of making a holographic optical element includes recording a first holographic pattern in the holographic optical element by concurrently providing a first beam for a first view point and a second beam from a target area; and recording a second holographic pattern in the holographic optical element by concurrently providing a third beam for a second view point that is distinct from the first view point and the second beam from the target area.

In accordance with some embodiments, a holographic medium is made by any of the methods described herein.

Thus, the disclosed embodiments provide eye-tracking systems and eye-tracking methods based on holographic media, and methods for making holographic media.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a perspective view of a display device in accordance with some embodiments.

FIG. 2 is a block diagram of a system including a display device in accordance with some embodiments.

FIG. 3 is an isometric view of a display device in accordance with some embodiments.

FIG. 4A is a schematic diagram illustrating an eye tracking device in accordance with some embodiments.

FIG. 4B is a schematic diagram illustrating an eye tracking device in accordance with some embodiments.

FIG. 4C is a schematic diagram illustrating an eye tracking device in accordance with some embodiments.

FIG. 4D is a schematic diagram illustrating an eye tracking device combined with a holographic illuminator in accordance with some embodiments.

FIGS. 5A-5D are schematic diagrams illustrating configurations of light patterns used for eye tracking in accordance with some embodiments.

FIG. 6A is a schematic diagram illustrating a display device with an eye tracking device in accordance with some embodiments.

FIG. 6B is a schematic diagram illustrating a display device with an eye tracking device in accordance with some embodiments.

FIG. 6C is a schematic diagram illustrating a display device with an eye tracking device in accordance with some embodiments.

FIG. 7A is a graphical representation of a multi-view image of an eye in accordance with some embodiments.

FIG. 7B shows multiple views of an eye in accordance with some embodiments.

FIG. 8A is a schematic diagram illustrating a system for making a multi-view holographic optical element in accordance with some embodiments.

FIG. 8B is a schematic diagram illustrating a prism used for making a multi-view holographic optical element in accordance with some embodiments.

These figures are not drawn to scale unless indicated otherwise.

### DETAILED DESCRIPTION

Eye-tracking systems with multi-view holographic optical elements provide accurate and reliable determination of a position of a pupil of an eye because views of the eye from multiple directions can be provided. The multiple views of the eye can be analyzed for accurate determination of the position of the pupil of the eye, while reducing the effect of occlusion in any single view. The disclosed embodiments provide (i) multi-view holographic optical elements, (ii) methods and systems for eye tracking with a multi-view holographic optical element, and (iii) methods for making such multi-view holographic optical elements.

In some embodiments, a multi-view holographic optical element is coupled with an imaging device (e.g., a camera) for converting the multiple views of the eye into electrical signals (e.g., a digital image). In some embodiments, the imaging device is configured for recording non-visible light (e.g., an infrared (IR) or near-infrared (NIR) light). In some embodiments, the imaging device is positioned away from the field-of-view of an eye.

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first surface could be termed a second surface, and, similarly, a second surface could be termed a first surface, without departing from the scope of the various described embodiments. The first surface and the second surface are both surfaces, but they are not the same surface.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “exemplary” is used herein in the sense of “serving as an example, instance, or illustration” and not in the sense of “representing the best of its kind.”

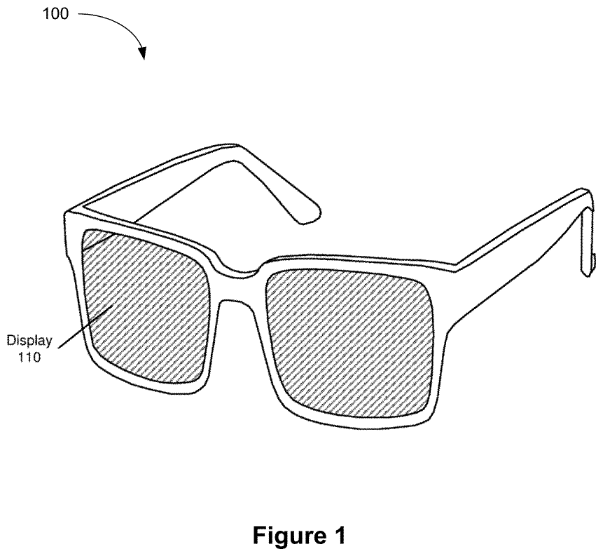

FIG. 1 illustrates display device 100 in accordance with some embodiments. In some embodiments, display device 100 is configured to be worn on a head of a user (e.g., by having the form of spectacles or eyeglasses, as shown in FIG. 1) or to be included as part of a helmet that is to be worn by the user. When display device 100 is configured to be worn on a head of a user or to be included as part of a helmet, display device 100 is called a head-mounted display. Alternatively, display device 100 is configured for placement in proximity of an eye or eyes of the user at a fixed location, without being head-mounted (e.g., display device 100 is mounted in a vehicle, such as a car or an airplane, for placement in front of an eye or eyes of the user). As shown in FIG. 1, display device 100 includes display 110. Display 110 is configured for presenting visual contents (e.g., augmented reality contents, virtual reality contents, mixed reality contents, or any combination thereof) to a user.

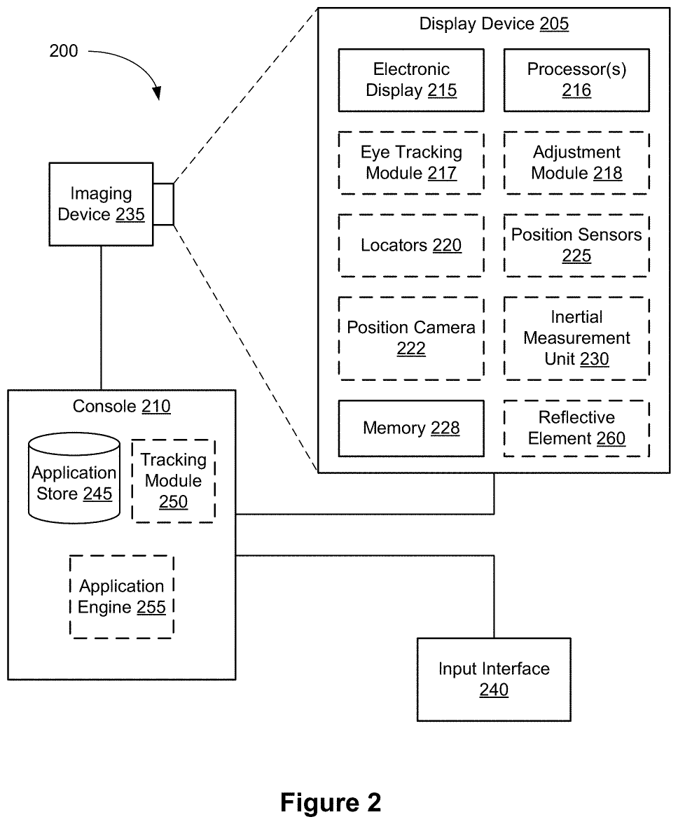

In some embodiments, display device 100 includes one or more components described herein with respect to FIG. 2. In some embodiments, display device 100 includes additional components not shown in FIG. 2.

FIG. 2 is a block diagram of system 200 in accordance with some embodiments. The system 200 shown in FIG. 2 includes display device 205 (which corresponds to display device 100 shown in FIG. 1), imaging device 235, and input interface 240 that are each coupled to console 210. While FIG. 2 shows an example of system 200 including one display device 205, imaging device 235, and input interface 240, in other embodiments, any number of these components may be included in system 200. For example, there may be multiple display devices 205 each having associated input interface 240 and being monitored by one or more imaging devices 235, with each display device 205, input interface 240, and imaging devices 235 communicating with console 210. In alternative configurations, different and/or additional components may be included in system 200. For example, in some embodiments, console 210 is connected via a network (e.g., the Internet) to system 200 or is self-contained as part of display device 205 (e.g., physically located inside display device 205). In some embodiments, display device 205 is used to create mixed reality by adding in a view of the real surroundings. Thus, display device 205 and system 200 described here can deliver augmented reality, virtual reality, and mixed reality.

In some embodiments, as shown in FIG. 1, display device 205 is a head-mounted display that presents media to a user. Examples of media presented by display device 205 include one or more images, video, audio, or some combination thereof. In some embodiments, audio is presented via an external device (e.g., speakers and/or headphones) that receives audio information from display device 205, console 210, or both, and presents audio data based on the audio information. In some embodiments, display device 205 immerses a user in an augmented environment.

In some embodiments, display device 205 also acts as an augmented reality (AR) headset. In these embodiments, display device 205 augments views of a physical, real-world environment with computer-generated elements (e.g., images, video, sound, etc.). Moreover, in some embodiments, display device 205 is able to cycle between different types of operation. Thus, display device 205 operate as a virtual reality (VR) device, an augmented reality (AR) device, as glasses or some combination thereof (e.g., glasses with no optical correction, glasses optically corrected for the user, sunglasses, or some combination thereof) based on instructions from application engine 255.

Display device 205 includes electronic display 215, one or more processors 216, eye tracking module 217, adjustment module 218, one or more locators 220, one or more position sensors 225, one or more position cameras 222, memory 228, inertial measurement unit (IMU) 230, one or more reflective elements 260 or a subset or superset thereof (e.g., display device 205 with electronic display 215, one or more processors 216, and memory 228, without any other listed components). Some embodiments of display device 205 have different modules than those described here. Similarly, the functions can be distributed among the modules in a different manner than is described here.

One or more processors 216 (e.g., processing units or cores) execute instructions stored in memory 228. Memory 228 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 228, or alternately the non-volatile memory device(s) within memory 228, includes a non-transitory computer readable storage medium. In some embodiments, memory 228 or the computer readable storage medium of memory 228 stores programs, modules and data structures, and/or instructions for displaying one or more images on electronic display 215.

Electronic display 215 displays images to the user in accordance with data received from console 210 and/or processor(s) 216. In various embodiments, electronic display 215 may comprise a single adjustable display element or multiple adjustable display elements (e.g., a display for each eye of a user). In some embodiments, electronic display 215 is configured to display images to the user by projecting the images onto one or more reflective elements 260.

In some embodiments, the display element includes one or more light emission devices and a corresponding array of spatial light modulators. A spatial light modulator is an array of electro-optic pixels, opto-electronic pixels, some other array of devices that dynamically adjust the amount of light transmitted by each device, or some combination thereof. These pixels are placed behind one or more lenses. In some embodiments, the spatial light modulator is an array of liquid crystal based pixels in an LCD (a Liquid Crystal Display). Examples of the light emission devices include: an organic light emitting diode, an active-matrix organic light-emitting diode, a light emitting diode, some type of device capable of being placed in a flexible display, or some combination thereof. The light emission devices include devices that are capable of generating visible light (e.g., red, green, blue, etc.) used for image generation. The spatial light modulator is configured to selectively attenuate individual light emission devices, groups of light emission devices, or some combination thereof. Alternatively, when the light emission devices are configured to selectively attenuate individual emission devices and/or groups of light emission devices, the display element includes an array of such light emission devices without a separate emission intensity array. In some embodiments, electronic display 215 projects images to one or more reflective elements 260, which reflect at least a portion of the light toward an eye of a user.

One or more lenses direct light from the arrays of light emission devices (optionally through the emission intensity arrays) to locations within each eyebox and ultimately to the back of the user's retina(s). An eyebox is a region that is occupied by an eye of a user located proximity to display device 205 (e.g., a user wearing display device 205) for viewing images from display device 205. In some cases, the eyebox is represented as a 10 mm×10 mm square. In some other cases, the eyebox is represented as a 20 mm×20 mm square. In some embodiments, the one or more lenses include one or more coatings, such as anti-reflective coatings.

In some embodiments, the display element includes an infrared (IR) detector array that detects IR light that is retro-reflected from the retinas of a viewing user, from the surface of the corneas, lenses of the eyes, or some combination thereof. The IR detector array includes an IR sensor or a plurality of IR sensors that each correspond to a different position of a pupil of the viewing user's eye. In alternate embodiments, other eye tracking systems may also be employed. As used herein, IR refers to light with wavelengths ranging from 700 nm to 1 mm including near infrared (NIR) ranging from 750 nm to 1500 nm (e.g., having a wavelength of 750 nm, 800 nm, 850 nm, 900 nm, 950 nm, 1000 nm, 1100 nm, 1200 nm, 1300 nm, 1400 nm, 1500 nm, or within a range between any two of the aforementioned values).

Eye tracking module 217 determines locations of each pupil of a user's eyes. In some embodiments, eye tracking module 217 instructs electronic display 215 to illuminate the eyebox with IR light (e.g., via IR emission devices in the display element).

A portion of the emitted IR light will pass through the viewing user's pupil and be retro-reflected from the retina toward the IR detector array, which is used for determining the location of the pupil. Alternatively, the reflection off of the surfaces of the eye (or an image of the eye) is used to also determine location of the pupil. The IR detector array scans for retro-reflection and identifies which IR emission devices are active when retro-reflection is detected. Eye tracking module 217 may use a tracking lookup table and the identified IR emission devices to determine the pupil locations for each eye. The tracking lookup table maps received signals on the IR detector array to locations (corresponding to pupil locations) in each eyebox. In some embodiments, the tracking lookup table is generated via a calibration procedure (e.g., user looks at various known reference points in an image and eye tracking module 217 maps the locations of the user's pupil while looking at the reference points to corresponding signals received on the IR tracking array). As mentioned above, in some embodiments, system 200 may use other eye tracking systems than the embedded IR one described herein.

Adjustment module 218 generates an image frame based on the determined locations of the pupils. In some embodiments, this sends a discrete image to the display that will tile subimages together thus a coherent stitched image will appear on the back of the retina. Adjustment module 218 adjusts an output (i.e. the generated image frame) of electronic display 215 based on the detected locations of the pupils. Adjustment module 218 instructs portions of electronic display 215 to pass image light to the determined locations of the pupils. In some embodiments, adjustment module 218 also instructs the electronic display to not pass image light to positions other than the determined locations of the pupils. Adjustment module 218 may, for example, block and/or stop light emission devices whose image light falls outside of the determined pupil locations, allow other light emission devices to emit image light that falls within the determined pupil locations, translate and/or rotate one or more display elements, dynamically adjust curvature and/or refractive power of one or more active lenses in the lens (e.g., microlens) arrays, or some combination thereof.

Optional locators 220 are objects located in specific positions on display device 205 relative to one another and relative to a specific reference point on display device 205. A locator 220 may be a light emitting diode (LED), a corner cube reflector, a reflective marker, a type of light source that contrasts with an environment in which display device 205 operates, or some combination thereof. In embodiments where locators 220 are active (i.e., an LED or other type of light emitting device), locators 220 may emit light in the visible band (e.g., about 500 nm to 750 nm), in the infrared band (e.g., about 750 nm to 1 mm), in the ultraviolet band (about 100 nm to 500 nm), some other portion of the electromagnetic spectrum, or some combination thereof.

In some embodiments, locators 220 are located beneath an outer surface of display device 205, which is transparent to the wavelengths of light emitted or reflected by locators 220 or is thin enough to not substantially attenuate the wavelengths of light emitted or reflected by locators 220. Additionally, in some embodiments, the outer surface or other portions of display device 205 are opaque in the visible band of wavelengths of light. Thus, locators 220 may emit light in the IR band under an outer surface that is transparent in the IR band but opaque in the visible band.

IMU 230 is an electronic device that generates calibration data based on measurement signals received from one or more position sensors 225. Position sensor 225 generates one or more measurement signals in response to motion of display device 205. Examples of position sensors 225 include: one or more accelerometers, one or more gyroscopes, one or more magnetometers, another suitable type of sensor that detects motion, a type of sensor used for error correction of IMU 230, or some combination thereof. Position sensors 225 may be located external to IMU 230, internal to IMU 230, or some combination thereof.

Based on the one or more measurement signals from one or more position sensors 225, IMU 230 generates first calibration data indicating an estimated position of display device 205 relative to an initial position of display device 205. For example, position sensors 225 include multiple accelerometers to measure translational motion (forward/back, up/down, left/right) and multiple gyroscopes to measure rotational motion (e.g., pitch, yaw, roll). In some embodiments, IMU 230 rapidly samples the measurement signals and calculates the estimated position of display device 205 from the sampled data. For example, IMU 230 integrates the measurement signals received from the accelerometers over time to estimate a velocity vector and integrates the velocity vector over time to determine an estimated position of a reference point on display device 205. Alternatively, IMU 230 provides the sampled measurement signals to console 210, which determines the first calibration data. The reference point is a point that may be used to describe the position of display device 205. While the reference point may generally be defined as a point in space; however, in practice the reference point is defined as a point within display device 205 (e.g., a center of IMU 230).

In some embodiments, IMU 230 receives one or more calibration parameters from console 210. As further discussed below, the one or more calibration parameters are used to maintain tracking of display device 205. Based on a received calibration parameter, IMU 230 may adjust one or more IMU parameters (e.g., sample rate). In some embodiments, certain calibration parameters cause IMU 230 to update an initial position of the reference point so it corresponds to a next calibrated position of the reference point. Updating the initial position of the reference point as the next calibrated position of the reference point helps reduce accumulated error associated with the determined estimated position. The accumulated error, also referred to as drift error, causes the estimated position of the reference point to “drift” away from the actual position of the reference point over time.

Imaging device 235 generates calibration data in accordance with calibration parameters received from console 210. Calibration data includes one or more images showing observed positions of locators 220 that are detectable by imaging device 235. In some embodiments, imaging device 235 includes one or more still cameras, one or more video cameras, any other device capable of capturing images including one or more locators 220, or some combination thereof. Additionally, imaging device 235 may include one or more filters (e.g., used to increase signal to noise ratio). Imaging device 235 is configured to optionally detect light emitted or reflected from locators 220 in a field of view of imaging device 235. In embodiments where locators 220 include passive elements (e.g., a retroreflector), imaging device 235 may include a light source that illuminates some or all of locators 220, which retro-reflect the light towards the light source in imaging device 235. Second calibration data is communicated from imaging device 235 to console 210, and imaging device 235 receives one or more calibration parameters from console 210 to adjust one or more imaging parameters (e.g., focal length, focus, frame rate, ISO, sensor temperature, shutter speed, aperture, etc.).

In some embodiments, display device 205 optionally includes one or more reflective elements 260. In some embodiments, electronic display device 205 optionally includes a single reflective element 260 or multiple reflective elements 260 (e.g., a reflective element 260 for each eye of a user). In some embodiments, electronic display device 215 projects computer-generated images on one or more reflective elements 260, which, in turn, reflect the images toward an eye or eyes of a user. The computer-generated images include still images, animated images, and/or a combination thereof. The computer-generated images include objects that appear to be two-dimensional and/or three-dimensional objects. In some embodiments, one or more reflective elements 260 are partially transparent (e.g., the one or more reflective elements 260 have a transmittance of at least 15%, 20%, 25%, 30%, 35%, 50%, 55%, or 50%), which allows transmission of ambient light. In such embodiments, computer-generated images projected by electronic display 215 are superimposed with the transmitted ambient light (e.g., transmitted ambient image) to provide augmented reality images.

Input interface 240 is a device that allows a user to send action requests to console 210. An action request is a request to perform a particular action. For example, an action request may be to start or end an application or to perform a particular action within the application. Input interface 240 may include one or more input devices. Example input devices include: a keyboard, a mouse, a game controller, data from brain signals, data from other parts of the human body, or any other suitable device for receiving action requests and communicating the received action requests to console 210. An action request received by input interface 240 is communicated to console 210, which performs an action corresponding to the action request. In some embodiments, input interface 240 may provide haptic feedback to the user in accordance with instructions received from console 210. For example, haptic feedback is provided when an action request is received, or console 210 communicates instructions to input interface 240 causing input interface 240 to generate haptic feedback when console 210 performs an action.

Console 210 provides media to display device 205 for presentation to the user in accordance with information received from one or more of: imaging device 235, display device 205, and input interface 240. In the example shown in FIG. 2, console 210 includes application store 245, tracking module 250, and application engine 255. Some embodiments of console 210 have different modules than those described in conjunction with FIG. 2. Similarly, the functions further described herein may be distributed among components of console 210 in a different manner than is described here.

When application store 245 is included in console 210, application store 245 stores one or more applications for execution by console 210. An application is a group of instructions, that when executed by a processor, is used for generating content for presentation to the user. Content generated by the processor based on an application may be in response to inputs received from the user via movement of display device 205 or input interface 240. Examples of applications include: gaming applications, conferencing applications, video playback application, or other suitable applications.

When tracking module 250 is included in console 210, tracking module 250 calibrates system 200 using one or more calibration parameters and may adjust one or more calibration parameters to reduce error in determination of the position of display device 205. For example, tracking module 250 adjusts the focus of imaging device 235 to obtain a more accurate position for observed locators on display device 205. Moreover, calibration performed by tracking module 250 also accounts for information received from IMU 230. Additionally, if tracking of display device 205 is lost (e.g., imaging device 235 loses line of sight of at least a threshold number of locators 220), tracking module 250 re-calibrates some or all of system 200.

In some embodiments, tracking module 250 tracks movements of display device 205 using second calibration data from imaging device 235. For example, tracking module 250 determines positions of a reference point of display device 205 using observed locators from the second calibration data and a model of display device 205. In some embodiments, tracking module 250 also determines positions of a reference point of display device 205 using position information from the first calibration data. Additionally, in some embodiments, tracking module 250 may use portions of the first calibration data, the second calibration data, or some combination thereof, to predict a future location of display device 205. Tracking module 250 provides the estimated or predicted future position of display device 205 to application engine 255.

Application engine 255 executes applications within system 200 and receives position information, acceleration information, velocity information, predicted future positions, or some combination thereof of display device 205 from tracking module 250. Based on the received information, application engine 255 determines content to provide to display device 205 for presentation to the user. For example, if the received information indicates that the user has looked to the left, application engine 255 generates content for display device 205 that mirrors the user's movement in an augmented environment. Additionally, application engine 255 performs an action within an application executing on console 210 in response to an action request received from input interface 240 and provides feedback to the user that the action was performed. The provided feedback may be visual or audible feedback via display device 205 or haptic feedback via input interface 240.

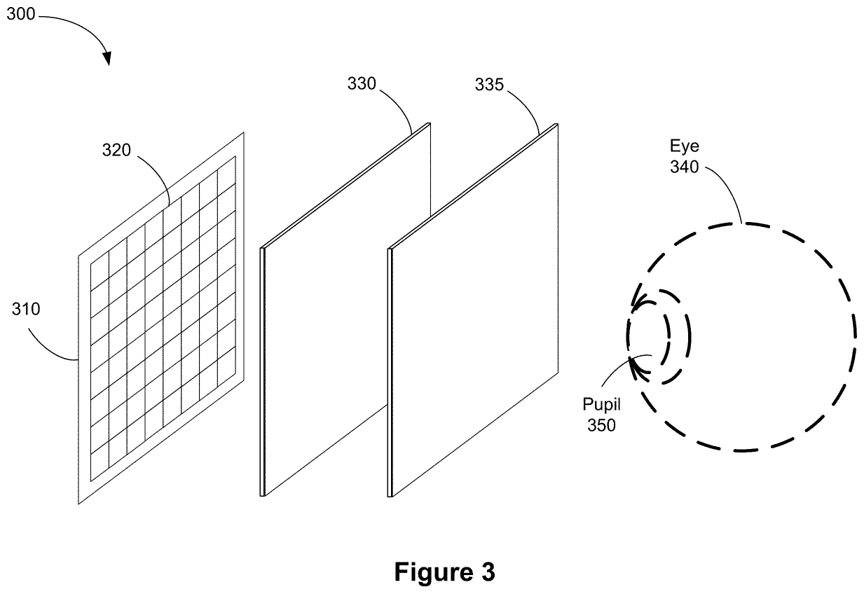

FIG. 3 is an isometric view of display device 300 in accordance with some embodiments. In some other embodiments, display device 300 is part of some other electronic display (e.g., a digital microscope, a head-mounted display device, etc.). In some embodiments, display device 300 includes light emission device array 310 and one or more lenses 330. In some embodiments, display device 300 also includes an IR detector array.

Light emission device array 310 emits image light and optional IR light toward the viewing user. Light emission device array 310 may be, e.g., an array of LEDs, an array of microLEDs, an array of OLEDs, or some combination thereof. Light emission device array 310 includes light emission devices 320 that emit light in the visible light (and optionally includes devices that emit light in the IR).

In some embodiments, display device 300 includes an emission intensity array configured to selectively attenuate light emitted from light emission array 310. In some embodiments, the emission intensity array is composed of a plurality of liquid crystal cells or pixels, groups of light emission devices, or some combination thereof. Each of the liquid crystal cells is, or in some embodiments, groups of liquid crystal cells are, addressable to have specific levels of attenuation. For example, at a given time, some of the liquid crystal cells may be set to no attenuation, while other liquid crystal cells may be set to maximum attenuation. In this manner, the emission intensity array is able to control what portion of the image light emitted from light emission device array 310 is passed to the one or more lenses 330. In some embodiments, display device 300 uses an emission intensity array to facilitate providing image light to a location of pupil 350 of eye 350 of a user, and minimize the amount of image light provided to other areas in the eyebox.

One or more lenses 330 receive the modified image light (e.g., attenuated light) from emission intensity array (or directly from emission device array 310), and direct the modified image light to a location of pupil 350.

In some embodiments, light emission device array 310 and an emission intensity array make up a display element. Alternatively, the display element includes light emission device array 310 (e.g., when light emission device array 310 includes individually adjustable pixels) without the emission intensity array. In some embodiments, the display element additionally includes the IR array. In some embodiments, in response to a determined location of pupil 350, the display element adjusts the emitted image light such that the light output by the display element is refracted by one or more lenses 330 toward the determined location of pupil 350, and not toward other locations in the eyebox.

In some embodiments, display device 300 includes one or more broadband sources (e.g., one or more white LEDs) coupled with a plurality of color filters, in addition to, or instead of, light emission device array 310.

In some embodiments, display device 300 also includes holographic optical element 335.

In some embodiments, light emission device array 310 is positioned within the field of view of eye 340 for virtual reality applications. In some embodiments, display device 300 also includes an optical waveguide or a combiner so that light emission device array 310 is positioned off the field of view of eye 340. Such configurations may be used for augmented reality applications.

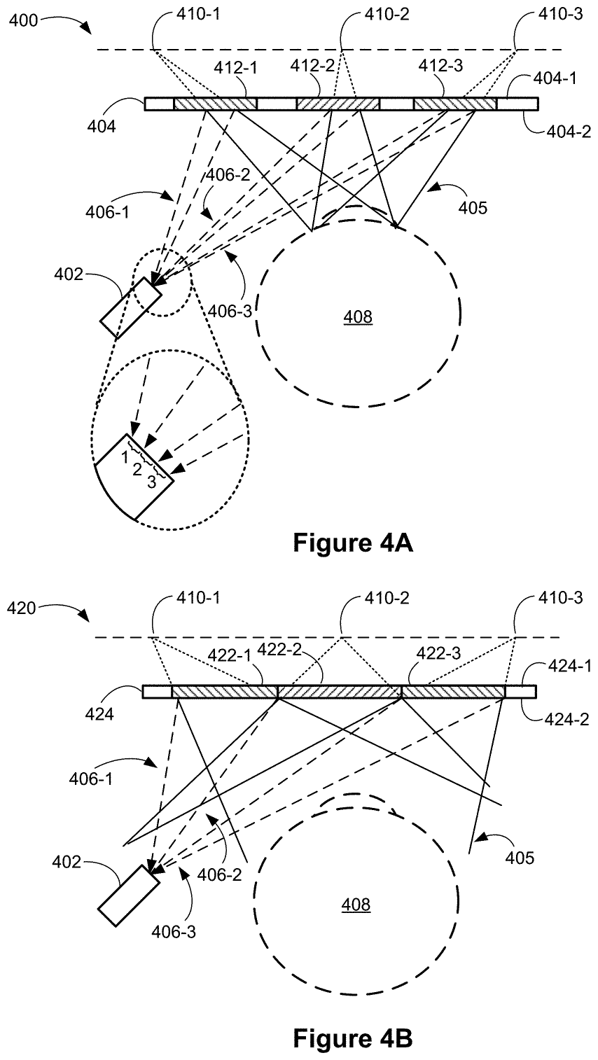

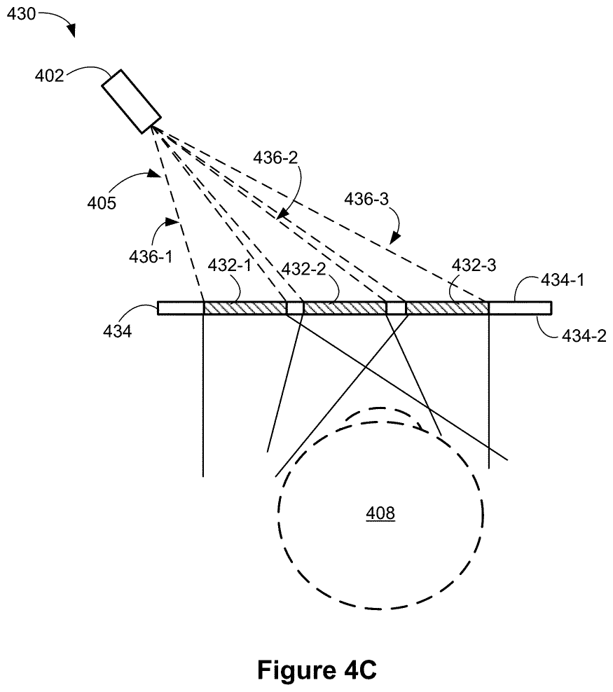

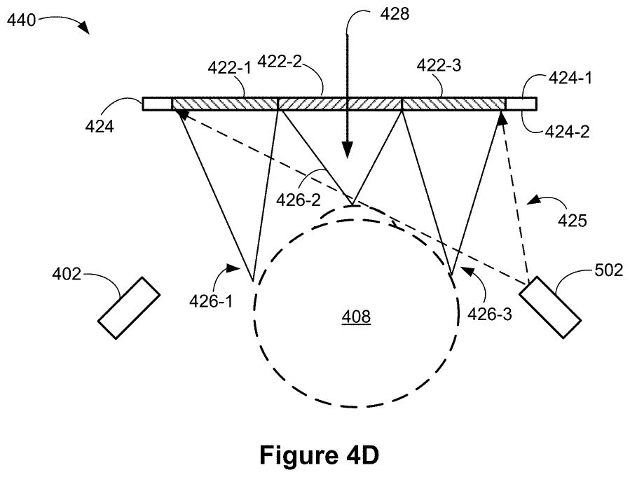

In some embodiments, an IR detector array detects IR light that has been retro-reflected from the retina of eye 350, a cornea of eye 350, a crystalline lens of eye 350, or some combination thereof. The IR detector array includes either a single IR sensor or a plurality of IR sensitive detectors (e.g., photodiodes). In some embodiments, the IR detector array is integrated into light emission device array 310. In some embodiments, the IR detector array is separate from light emission device array 310, as shown in FIG. 4A.

FIG. 4A is a schematic diagram illustrating eye tracking device 400 in accordance with some embodiments. Eye tracking device 400 includes imaging device 402 (e.g., a camera, such as an infrared camera) and holographic medium 404. Holographic medium 404 is a holographic medium for projecting multiple views of an eye of a user (e.g., a user of a head-mounted display device). In some embodiments, holographic medium 404 is a wide-field holographic medium. In some cases, a wide-field holographic medium refers to a holographic medium configured to project images of an area with a characteristic dimension of at least 10 mm (e.g., imaging an area of at least 10 mm, 15 mm, 20 mm, 25 mm, or 30 mm in diameter or length).

In FIG. 4A, imaging device 402 is located away from an optical axis of holographic medium 404. In some embodiments, imaging device 402 is located away from an optical axis of a lens (e.g., lens 330 in FIG. 3) of a head-mounted display device. In some embodiments, imaging device 402 is located away from a field of view of eye 408 (e.g., eye 408 corresponds to an eye of a user of a head-mounted display device). By providing an off-axis imaging, imaging device 402 does not occlude the field of view of eye 408. In some embodiments, imaging device 402 is positioned on the optical axis of holographic medium 404.

In FIG. 4A, multiple views of eye 408 are projected by holographic medium 404 toward imaging device 402. In FIG. 4A, holographic medium 404 is a reflection holographic medium, having surface 404-1 and surface 404-2, with one or more recorded interference patterns. The one or more recorded interference patterns modify light (e.g., infrared light reflected off by an eye) impinging on recorded interference patterns and project one or more holographic patterns. In FIG. 4A, light 405 from eye 408 is received by surface 404-2 of holographic medium 404 (e.g., a surface of holographic medium 404 facing eye 408). Holographic medium 404 includes areas 412-1, 412-2, and 412-3 that are configured to interact with light 405 from eye 408 and concurrently direct (e.g., reflect, diffract, etc.) separate portions 406-1, 406-2, and 406-3 of light 405 toward imaging device 402. In some embodiments, portions 406-1, 406-2, and 406-3 of light 405 correspond to images (or views) of eye 408 from three distinct virtual view points 410-1, 410-2, and 410-3. For example, portion 406-1 of light 405 corresponds to a view of eye 408 from view point 410-1, portion 406-2 of light 405 corresponds to a view of eye 408 from view point 410-2, and portion 406-3 of light 405 corresponds to a view of eye 408 from view point 410-3. In addition, portions 406-1, 406-2, and 406-3 of light 405 are directed toward imaging device 402 at distinct angles. For example, portion 406-1 of light 405 is directed toward imaging device 402 at a first angle, portion 406-2 of light 405 is directed toward imaging device 402 at a second angle, and portion 406-3 of light 405 is directed toward imaging device 402 at a third angle.

In some embodiments, portions 406-1, 406-2, and 406-3 of light 405 are projected onto distinct portions of the imaging device 402. For example, the inset of FIG. 4A shows that portion 406-1 of light 405 is projected onto a first portion 1 of the imaging device 402, portion 406-2 of light 405 is projected onto a second portion 2 of the imaging device 402, and portion 406-3 of light 405 is projected onto a third portion 3 of the imaging device 402.

In some embodiments, holographic medium 404 has a limited angular and/or spectral selectivity. For example, holographic medium 404 reflects light 402-1 with a specific wavelength range and/or with a specific distribution of incident angles while transmitting light with wavelengths outside the specific wavelength range and/or with incident angles outside the specific distribution of incident angles. In some embodiments, holographic medium 404 reflects light in the IR (e.g., NIR) wavelength range. This allows holographic medium 404 to be used in a virtual reality device (e.g., holographic medium 404 is placed in front of a display panel, transmitting visible light from the display panel) or an augmented reality device (e.g., holographic medium 404 transmits visible ambient light).

In some embodiments, holographic medium 404 is a volume hologram (also called a Bragg hologram). A volume hologram refers to a hologram with thickness sufficiently large for inducing Bragg diffraction, i.e., the thickness of the recording material used for recording a volume hologram is significantly larger than the wavelength of light used for recording the hologram. Such holograms have spectral selectivity, angular selectivity of an incident light and/or selectivity with respect to wavefront profile of an incident light.

FIG. 4B is a schematic diagram illustrating eye tracking device 420 in accordance with some embodiments. Eye tracking device 420 is similar to eye tracking device 400 described above with respect to FIG. 4A, except that eye tracking device 420 includes holographic medium 424 instead of holographic medium 404. Holographic medium 424 includes areas 422-1, 422-2, and 422-3 configured to interact with light 405 and concurrently direct (e.g., reflect, diffract, etc.) separate portions 406-1, 406-2, and 406-3 of light 405 toward imaging device 402. Areas 422-1, 422-2, and 422-3 are in contact with each other (e.g., areas 422-1 and 422-3 are in contact with area 422-2), while areas 412-1, 412-2, and 412-3 of holographic medium 404 may not be in contact with each other (e.g., none of areas 412-1, 412-2, and 413-3 is in contact with any other of areas 412-1, 412-2, and 412-3). In some embodiments, a holographic medium includes (i) a first area configured for interacting with light 405 and directing at least a portion of light 405 where the second area is not adjacent to (e.g., not in contact with) any other area configured for interacting with light 405 and directing at least a portion of light 405 and (ii) a second area configured for interacting with light 405 and directing at least a portion of light 405 where the second area is adjacent to (e.g., in contact with) another area configured for interacting with light 405 and directing at least a portion of light 405.

FIG. 4C is a schematic diagram illustrating eye tracking device 430 in accordance with some embodiments. Eye tracking device 430 is similar to eye tracking device 400 described above with respect to FIG. 4A, except that eye tracking device 430 includes holographic medium 434, which is a transmission holographic medium having surfaces 434-1 and 434-2. Imaging device 402 is positioned away from an optical axis of holographic medium 434 and away from a field of view of eye 408. In eye tracking device 430, imaging device 402 is positioned on opposite side of holographic medium 434 from eye 408, facing surface 434-1 of holographic medium 434 (e.g., imaging device 402 is positioned closer to surface 434-1 of holographic medium 434 than surface 434-2 of holographic medium 434 facing eye 408). Holographic medium 434 includes areas 432-1, 432-2, and 432-3 that are configured to interact with light 405 and concurrently direct separate portions 436-1, 436-2, and 436-3 of light 405 toward eye 408. Similar to the corresponding portions 406-1, 406-2, and 406-3 of light 405 shown in FIG. 4A, portions 436-1, 436-2, and 436-3 of light 405, in some embodiments, correspond to views of eye 408 from different view points.

FIG. 4D is a schematic diagram illustrating eye tracking device 440 in accordance with some embodiments. Eye tracking device 440 is similar to eye tracking device 420 shown in FIG. 4B, except that eye tracking device 440 also includes one or more light sources 502. As explained above with respect to FIG. 4B, holographic medium 424 projects portions 406-1, 406-2, and 406-3 of light 405 corresponding to views of eye 408 by toward imaging device 402, and portions 406-1, 406-2, and 406-3 of light 405 projected by holographic medium 424 toward imaging device 402 are not shown in FIG. 4D so as not to obscure other aspects of eye tracking device 440. One or more light sources 502 provide light 425 (e.g., infrared light) toward holographic medium 424, which in turn projects one or more light patterns 426-1, 426-2, and 426-3 toward eye 408. Light patterns projected by holographic medium 424 (e.g., light patterns 426-1, 426-2, and 426-3) are projected toward eye 408 at respective angles. Although FIG. 4D shows that holographic medium 424 projects one or more light patterns 426-1, 426-2, and 426-3 toward eye 408, any other holographic medium described herein (e.g., holographic medium 404 shown in FIG. 4A) may be configured to project one or more light patterns (e.g., light patterns 426-1, 426-2, and 426-3) toward eye 408.

FIG. 4D also shows that in some embodiments, holographic medium 424 transmits ambient light 428. For example, holographic medium 424 may be configured to direct (e.g., reflect or diffract) infrared light and transmit visible light so that components of light having visible wavelengths are transmitted through holographic medium 424.

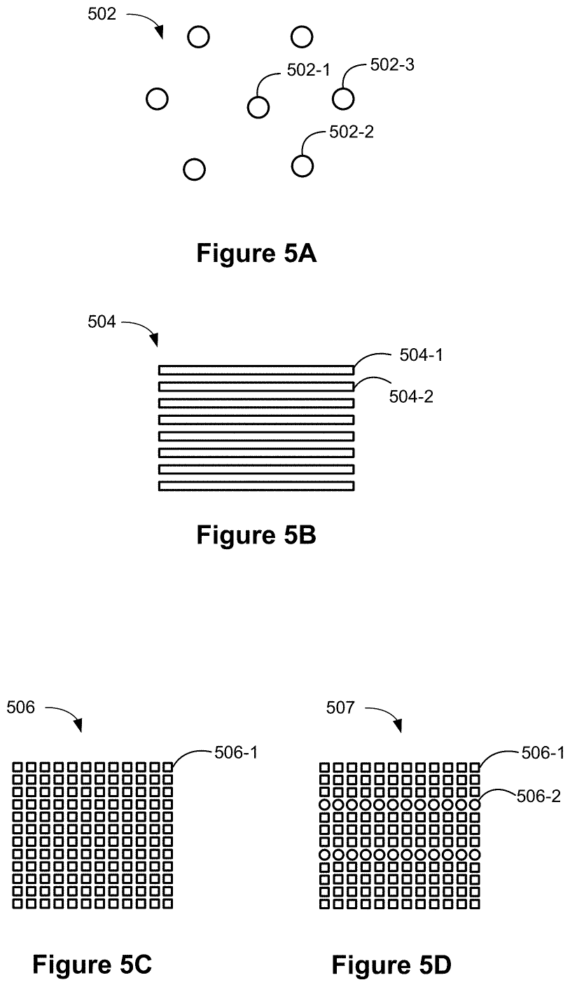

FIGS. 5A-5D are schematic diagrams illustrating configurations of light patterns used for eye tracking in accordance with some embodiments. The example light patterns illustrated in FIGS. 5A-5D are used for in-field illumination of an eye. In some embodiments, the eye is illuminated with an IR or NIR light for eye-tracking purposes (e.g., the light patterns illustrated in FIG. 5A-5D are illuminated with an IR or NIR light). In some embodiments, the light patterns shown in FIG. 5A-5D are configured to illuminate an area with a characteristic dimension (e.g., a diameter or width) of at least 10 mm on a surface of the eye (e.g., 10 mm, 15 mm, 20 mm, 25 mm, 30 mm, etc.). The configurations shown in FIGS. 5A-5D include a plurality of distinct and separate light patterns (e.g., image objects or image structures, such as light patterns 502-1, 502-2, and 502-3 in FIG. 5A), arranged in a uniform or a non-uniform configuration. In some embodiments, a number of patterns in the plurality of separate light patterns is between 5 and 2000. In some embodiments, the number of light patterns in a particular configuration is between seven and twenty. In some embodiments, the number of light patterns is between 20 and 1000. In some embodiments, the number of light patterns is between 1000 and 2000. In some embodiments, the light patterns have one or more predefined shapes, such as circles (e.g., spots), stripes, triangles, squares, polygons, crosses, sinusoidal objects and/or any other uniform or non-uniform shapes.

FIG. 5A illustrates configuration 502 including seven separate light patterns (e.g., light patterns 502-1, 502-2, and 502-3). In FIG. 5A, each light pattern has a shape of a circle (e.g., a solid circle or a hollow circle). Multiple light patterns (e.g., light patterns 502-1 and 502-2 among others) are arranged in a circular configuration with light pattern 502-3 positioned at the center of the circular configuration. In some embodiments, configuration 502 includes light patterns arranged in a plurality of concentric circles (e.g., 2, 3, 4, 5 circles or more). In some embodiments, configuration 502 does not include a central light pattern (e.g., light pattern 502-3).

FIG. 5B illustrates rectangular configuration 504 including a plurality (e.g., eight) of separate stripe-shaped light patterns (e.g., light patterns 504-1 and 504-2).

FIG. 5C illustrates configuration 506 including a plurality of light patterns arranged in a two-dimensional configuration (e.g., a rectangular configuration). In FIG. 5C, the plurality of light patterns is arranged in multiple rows and multiple columns (e.g., 144 light patterns arranged in twelve rows and twelve columns). In some embodiments, the plurality of light patterns is arranged to have a uniform spacing in a first direction and a uniform spacing in a second direction that is distinct from the first direction (e.g., the second direction is orthogonal to the first direction). In some embodiments, the plurality of light patterns is arranged to have a first spacing in the first direction and a second spacing in the second direction that is distinct from the first spacing. In some embodiments, the plurality of light patterns is arranged to have a uniform spacing in the first direction and a non-uniform spacing in the second direction. In some embodiments, the plurality of light patterns is arranged to have a uniform center-to-center distance in the first direction and a uniform center-to-center distance in the second direction. In some embodiments, the plurality of light patterns is arranged to have a first center-to-center distance in the first direction and a second center-to-center distance in the second direction that is distinct from the first center-to-center distance. In some embodiments, the plurality of light patterns is arranged to have a uniform center-to-center distance in the first direction and a non-uniform center-to-center distance in the second direction.

In FIG. 5C, each light pattern has a same shape (e.g., a square, rectangle, triangle, circle, ellipse, oval, star, polygon, etc.).

FIG. 5D is similar to FIG. 5C, except that, in FIG. 5D, configuration 507 of the plurality of light patterns includes a first set of light patterns 506-1 each having a first shape (e.g., a square or a rectangle) and a second set of light patterns 506-2 each having a second shape (e.g., a circle) that is distinct from the first shape.

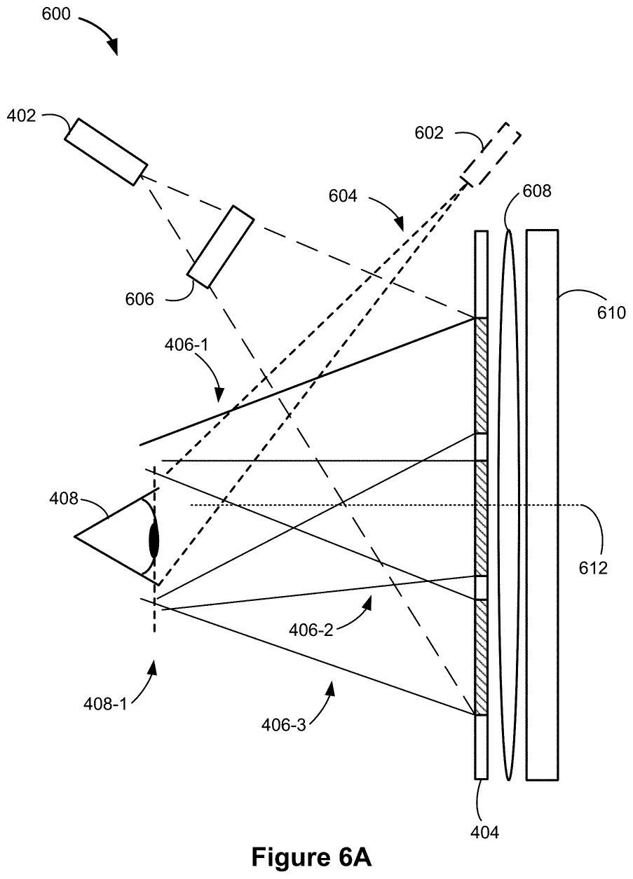

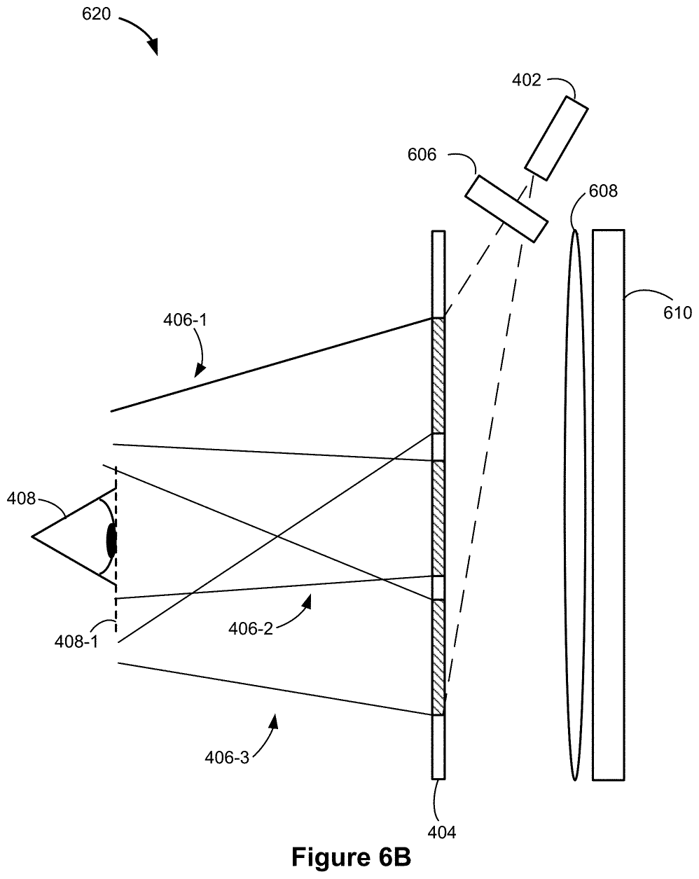

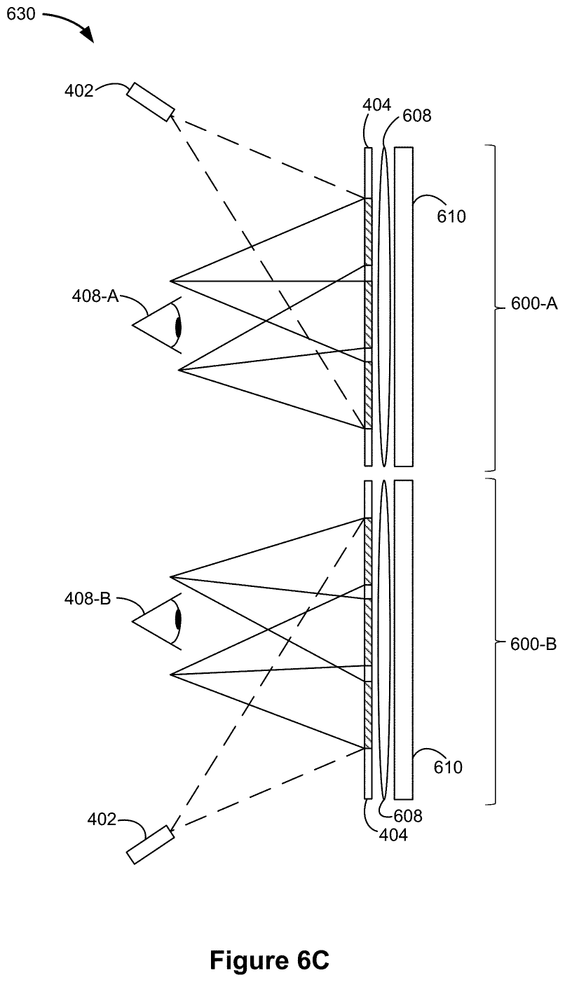

FIG. 6A is a schematic diagram illustrating display device 600 in accordance with some embodiments. In some embodiments, display device 600 is configured to provide virtual reality content to a user. In some embodiments, display device 600 corresponds to display device 100 described above with respect to FIG. 1. In FIG. 6A, display device 600 includes imaging device 402, holographic medium 404, display panel 610 and one or more lenses 608. Holographic medium 404 optically coupled with imaging device 402 operates as an eye tracking device described above with respect to FIG. 4A. In some embodiments, display device 600 also includes optics 606. In some embodiments, optics 606 includes an aspheric lens for correcting distortions in the multiple views of eye 408 due to off-axis projection by holographic medium 404. In some embodiments, the aspheric lens in optics 606 is an asymmetric lens.

In some embodiments, display device 600 also includes light source 602. In some embodiments, as shown in FIG. 6A, light source 602 provides a pattern of light 604 directly toward eye 408. In some embodiments, light source 602 provides light to holographic medium 404, which then projects the light as light patterns toward eye 408 as shown in FIG. 4D. When display device 600 includes light source 602, detector 402 captures an image (e.g., an image of an area encompassing eye 408) of at least a portion of light patterns reflected off a surface (e.g., a sclera) of eye 408, directed by holographic medium 404 toward detector 402 for determining a position of a pupil of eye 408.

Holographic medium 404, imaging device 402, and light source 602 of an eye-tracking system are configured to determine a position of the pupil of eye 408 and/or track its movement as eye 408 rotates toward different gaze directions. In some embodiments, the eye tracking system corresponds to, is coupled with, or is included in eye tracking module 217 described herein with respect to FIG. 2. In some embodiments, imaging device 402 is an IR and/or NIR camera (e.g., a still camera or a video camera) or other IR and/or NIR sensitive photodetector (e.g., an array of photodiodes). In some embodiments, determining a position of the pupil includes determining the position of the pupil on an x-y plane of the pupil (e.g., reference plane 408-1). In some embodiments, the x-y plane is a curvilinear plane. In some embodiments, light source 602 is integrated with imaging device 402. In some embodiments, light projected by light source 602 (e.g., light 604) and an image captured by imaging detector 402 have the same optical path (or parallel optical paths) and are transmitted or guided by the same optical elements (e.g., holographic medium 404).

In some embodiments, the position of the pupil of eye 408 is determined based on a representative intensity or intensities of detected glints. In some embodiments, the position of the pupil is determined based on an incident angle of detected glints (e.g., display device 600 includes one or more optical elements to determine the incident angle of the detected glint). For example, the position of the pupil is determined by comparing an incident angle of reflected light patterns to an estimated surface profile of the surface of eye 408. The surface profile of an eye does not correspond to a perfect sphere but instead has a distinct curvature in the area that includes the cornea and the pupil. Therefore, a position of the pupil can be determined by determining the surface profile of the eye.

In some embodiments, at least a portion of light patterns impinges on other surfaces of eye 408 than sclera (e.g., the pupil). In some embodiments, the position of the pupil is determined based on a portion of light patterns impinging on the sclera and impinging on the other surfaces of eye 408. In some embodiments, the position of the pupil of eye 408 is determined based on a difference (and/or a ratio) between an intensity of a portion of light patterns impinging on the sclera and on the pupil. For example, the intensity of the portion of light patterns reflected on the sclera of eye is higher than the intensity the portion of light patterns reflected on the pupil and therefore the location of the pupil can be determined based on the intensity difference.

In some embodiments, the position of the pupil of eye 408 is determined based on a difference in a configuration (e.g., configurations described above with respect to FIG. 5A-5D) projected by the holographic illuminator and a configuration captured by imaging device 402. For example, as a light with a specific configuration is reflected off the non-flat surface of eye 408, the structured pattern is modified (e.g., distorted). The non-flat surface profile of eye 408 is then determined based on the distorted structured pattern and the position of the pupil is determined based on the surface profile.

In some embodiments, a gaze angle of the eye and/or a state of the eye (e.g., whether its eye lid is open or closed) may be also determined (e.g., based on an image of the eye or intensities of glints detected by imaging device 402).

In FIG. 6A, imaging device 402 and light source 602 are located away from an optical axis 612 of holographic medium 404, as well as away from optical axes of one or more lenses 608 and display 610. For example, imaging device 402 and light source 602 are position on a temple and/or a frame of a head-mounted display device. Furthermore, imaging device 402 and light source 602 are positioned away from a field-of-view of eye 408 so that they do not occlude display panel 610. In FIG. 6A, holographic medium 404 is positioned adjacent to one or more lenses 608. Holographic medium 404 is configured to provide light patterns in the field-of-view of eye 408. In FIG. 6A, holographic medium 404 is a reflection holographic medium, and imaging device 402 is located to illuminate a surface of holographic medium 404 that is configured to face eye 408.

In some embodiments, holographic medium 404 is wavelength selective, thereby reflecting light with a specific wavelength range while transmitting light with other wavelengths, such as light from display panel 610. In some embodiments, light used for eye-tracking is IR or NIR light, and therefore does not interfere with visible light projected from display panel 610.

FIG. 6B is a schematic diagram illustrating display device 620 in accordance with some embodiments. Display device 620 is similar to display device 600 described above with respect to FIG. 6A, except that holographic medium 404 is a transmission holographic medium and imaging device 402 is located on an opposite side of holographic medium 404 from eye 408.

FIG. 6C is a schematic diagram illustrating display device 630 in accordance with some embodiments. Display device 630 includes display device 600-A for eye 408-A (e.g., the left eye of a user of a head-mounted display device 630) and display device 600-B for eye 408-B (e.g., the right eye of a user of a head-mounted display device 630). In some embodiments, each of display devices 600-A and 600-B corresponds to display device 600 described above with respect to FIG. 6A. In some embodiments, a head-mounted display includes two display devices, each corresponding to display device 620 described above with respect to FIG. 6B. In some embodiments, display device 630 corresponds to display device 100 described above with respect to FIG. 1.

In some embodiments, display device 630 includes holographic medium 404 at a location having a distance (e.g., eye relief) of at least 10 mm, 11 mm, 12 mm, 13 mm, 14 mm, 15 mm, 16 mm, 17 mm, 18 mm, 19 mm, 20 mm, or within a range between any two of the aforementioned values, to eye 408 of a user when display device 630 is worn by the user.

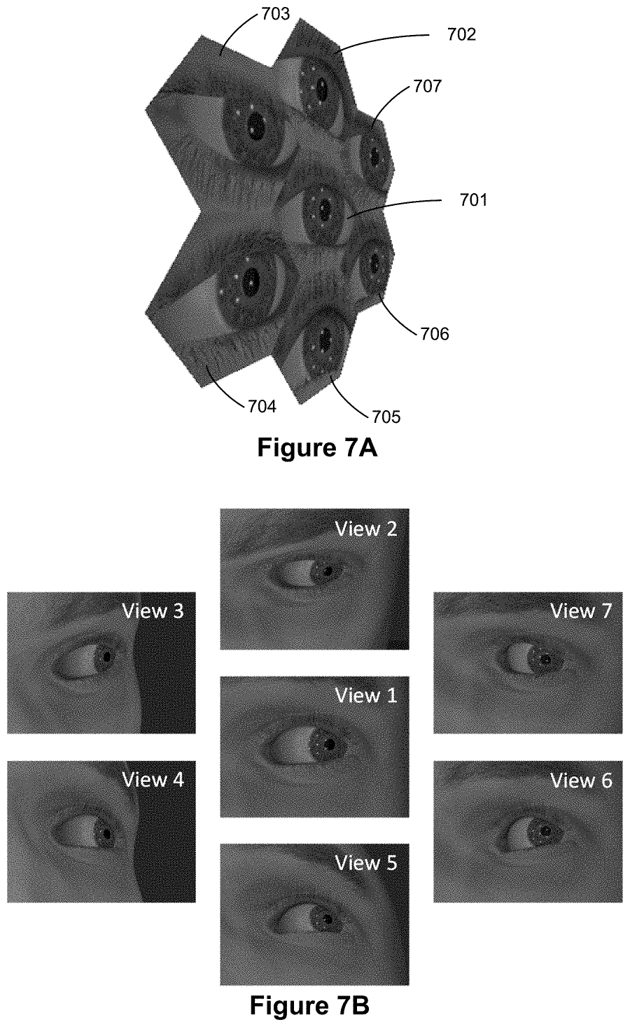

FIG. 7A is a graphical representation of a multi-view image of an eye in accordance with some embodiments. The multi-view image of the eye shown in FIG. 7A includes multiple views of the same eye shown in FIG. 7B, tiled adjacent to one another. In FIG. 7A, the multi-view image includes seven views of the eye, but in some other implementations, additional views, or fewer views, may be used (e.g., 2, 3, 4, 5, 6, 8, 9, 10, 11, 12, 13, 14, 15, 16, 17, 18, 19, 20, 30, 40, 50, 60, 70, 80, 90, or 100 views or a number of views within a range between any two of the forementioned values).

Each view shown in FIGS. 7A and 7B illustrates a plurality of glints arranged in a pattern shown in FIG. 5A. A position of a pupil of the reference eye can be determined based on the multiple views. Although the multiple views of the eye may be obtained separately by taking images at different times or by using multiple imaging devices, the use of the multi-view holographic optical element described herein allows concurrent collection (or taking) of the multiple views in a single image, while using fewer components. Thus, the use of the multi-view holographic optical element may reduce the size and weight of the display device. In some embodiments, the position of a pupil of the reference eye is determined based on intensities of respective glints. In some embodiments, the position of the pupil of the reference eye is determined based on locations of respective glints.

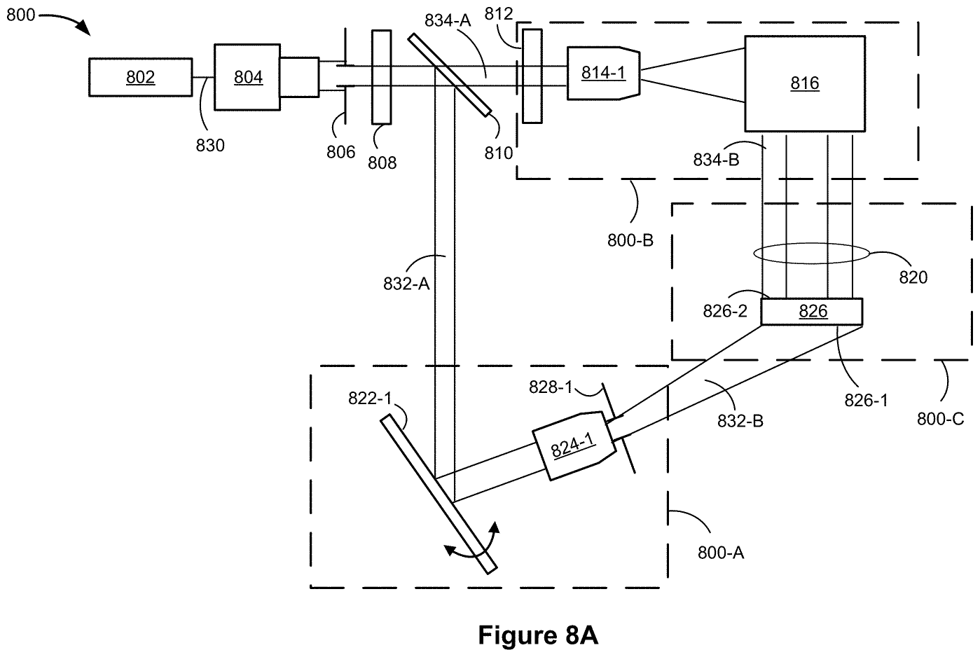

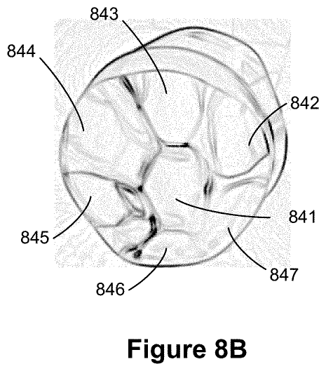

FIG. 8A is a schematic diagram illustrating system 800 for making a multi-view holographic optical element in accordance with some embodiments. System 800 includes light source 802. In some embodiments, light source 802 is a point-light source (e.g., a laser). In some embodiments, beam 830 provided by light source 802 is coherent light. Light source 802 is optionally coupled optically with a plurality of optical components for modifying beam 830, such as beam expander 804 that expands beam 830 and aperture 806 for adjusting the beam size of beam 830. In some embodiments, beam 830 provided by light source 802 has a beam size with diameter less than 1 mm, which is then expanded to a beam size with a diameter greater than 10 mm, which is, in turn, clipped to a beam size with a diameter between 7 mm and 9 mm by aperture 806. In some embodiments, light source 802 provides a monochromatic light. In some embodiments, the monochromatic light has a center wavelength at 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 850 nm, 900 nm, 950 nm, 1000 nm, 1050 nm, 1100 nm, or within a range between any two of the aforementioned values.

In some embodiments, system 800 includes polarizer 808 and a polarization of beam 830 is adjusted by polarizer 808. For example, in some implementations, polarizer 808 is a half-wave plate configured to adjust a direction of a linear polarized light.

In FIG. 8A, beam 830 is divided into two physically separated beams 832-A and 834-A by beam splitter 810. In some embodiments, beam splitter 810 is a 50/50 reflector (e.g., beam 832-A and beam 834-A have the same intensity). In some embodiments, beam splitter 810 is a polarizing beam splitter dividing beam 830 into beam 832-A with a first polarization (e.g., polarization in the vertical direction) and beam 834-A with a second polarization (e.g., polarization in the horizontal direction). In some embodiments, a combination of a half-wave plate (e.g., polarizer 808) and a polarizing beam splitter (e.g., beam splitter 810) is used for adjusting intensities of beams 832-A and 834-A and/or adjusting a ratio of intensities of beams 832-A and 834-A. For example, in some implementations, the intensities are adjusted by changing the orientation of the half-wave plate. In some embodiments, the polarization of one or more of the beams 832-A and 834-A is further adjusted by one or more polarizers (e.g., polarizer 812, which can be a half-way plate). In FIG. 8A, polarizer 812 of a second set of optical elements 800-B adjusts the polarization of beam 834-A to correspond to the polarization of beam 832-A. In some implementations, polarizer 812 is included in a first set of optical elements 800-A for adjusting the polarization of beam 832-A.

Beam 832-A is directed, for example by beam splitter 810, toward the first set of optical elements 800-A. The first set of optical elements 800-A includes optical elements for providing an illumination serving as a reference light in a formation of a holographic medium. In some embodiments, the first set of optical elements 800-A includes reflector 822-1, which directs beam 832-A toward lens 824-1. In some embodiments, the first set of optical elements 800-A includes lens 824-1 for expanding beam 834-A and transmitting beam 832-B toward optically recordable medium 826. In some embodiments, the first set of optical elements 800-A includes a subset, or a superset of optical components illustrated in FIG. 8A. For example, the first set of optical elements 800-A may include other optical elements, that are not illustrated in FIG. 8A, for providing an illumination onto optically recordable medium 826. In some implementations, the first set of optical elements 800-A may not include one or more optical elements illustrated as components of the first set of optical elements 800-A in FIG. 8A. A beam has a spot size applicable for illuminating, with a single exposure, an area on optically recordable medium 826 for forming any of the holographic mediums described above with respect to FIGS. 4A-4D. In some embodiments, a beam refers to a beam with a spot size with a characteristic dimension (e.g., a diameter or width) of at least 10 mm. In some embodiments, a beam refers to a beam with a spot size with a characteristic dimension (e.g., a diameter or width) of at least 100 mm. In some embodiments, lens 824-1 is a microscopic objective (e.g., lens 824-1 is a microscopic objective with 20× magnification with numerical aperture of 0.4). In some embodiments, lens 824-1 is a lens assembly including two or more lenses. Optionally, lens 824-1 is optically coupled with aperture 828-1 for adjusting a size of beam 832-B. In some embodiments, aperture 828-1 has a diameter between 5 mm and 6 mm. In some embodiments, aperture 828-1 has a diameter between 6 mm and 7 mm. In some embodiments, aperture 828-1 has a diameter between 7 mm and 8 mm. In some embodiments, aperture 828-1 has a diameter between 8 mm and 9 mm. In some embodiments, aperture 828-1 has a diameter between 9 mm and 10 mm. In some embodiments, aperture 828-1 has a diameter between 10 mm and 11 mm. In some embodiments, reflector 822-1 is an adjustable reflector configured for adjusting the direction of beam 832-A, thereby adjusting the direction of beam 832-B transmitted from lens 824-1 toward optically recordable medium 826. In some implementations, beam 832-B provides a single-shot off-axis illumination with a diameter of at least 10 mm (e.g., 100 mm or more) onto surface 826-1 of optically recordable medium 826.

In some embodiments, optically recordable medium 826 includes photosensitive polymers, silver halide, dichromatic gelatin and/or other standard holographic materials. In some embodiments, optically recordable medium 826 includes other types of wavefront shaping materials (e.g., metamaterials, polarization sensitive materials, etc.). In some embodiments, optically recordable medium 826 has a thickness (e.g., distance between surfaces 826-1 and 826-2) that is much greater than the wavelength of lights 832-B and 834-B in order to record a volume hologram.

In some embodiments, optically recordable medium 826 is coupled with a waveguide (e.g., waveguide 456 in FIG. 4E) in order to record a holographic medium (e.g., holographic medium 454) that is configured to receive light propagating through a waveguide, as described above with respect to holographic illuminator 450 in FIG. 4E.

Beam 834-A is directed, by beam splitter 810, toward the second set of optical elements 800-B. The second set of optical elements 800-B includes optical elements for providing an illumination to a third set of optical elements 800-C.

In some embodiments, the second set of optical elements 800-B includes lens 814-1 and multi-faceted prism 816. In some embodiments, the second set of optical elements 800-B includes a subset, or a superset of optical components illustrated in FIG. 8A. For example, the first set of optical elements 800-A may include other optical elements, that are not illustrated in FIG. 8A, for providing an illumination to the third set of optical elements 800-C. In some implementations, the second set of optical elements 800-B may not include one or more optical elements illustrated as components of the second set of optical elements 800-B in FIG. 8A.

In some embodiments, lens 814-1 is a microscopic objective (e.g., lens 814-1 is a microscopic objective with 20× magnification and a numerical aperture of 0.4) configured to expand beam 834-A. In some embodiments, lens 814-1 is a lens assembly including two or more lenses. In FIG. 8A, lens 814-1 transmits beam 834-A toward multi-faceted prism 816. Multi-faceted prism 816 collimates beam 834-A and reflects collimated beam 834-B toward the third set of optical elements 800-C. In some embodiments, multi-faceted prism 816 includes multiple facets for forming multiple regions (e.g., regions 412-1, 412-2, and 412-3) in optically recordable medium 826. In some embodiments, the combination of lens 814-1 and multi-faceted prism 816 expands beam 834-A such that beam 834-B has a beam diameter of 10 mm or more. For example, the combination of lens 814-1 and multi-faceted prism 816 is configured to expand beam 834-A with a beam diameter of 8 mm into a beam 834-B with a beam diameter of 100 mm.

In FIG. 8A, multi-faceted prism 816 of the second set of optical elements 800-B is located to intersect with an optical axis of the holographic medium formed from optically recordable medium 826 (e.g., an axis that is perpendicular to the holographic medium). In some embodiments, two or more multi-faceted prisms are used. In some implementations, multi-faceted prism 816 directs at least a portion of beam 834-B onto optically recordable medium 826 in a direction perpendicular to optically recordable medium 826 (for 0° angle of diffraction), thereby providing an on-axis illumination onto surface 826-2 of optically recordable medium 826 while beam 832-B provides an off-axis illumination onto surface 826-1 of optically recordable medium 826 (e.g., for an angle of incidence having 15°, 30°, 45°, 60°, 75° or within a range between any two of the aforementioned values). In some implementations, multi-faceted prism 816 directs at least a portion of beam 834-B onto optically recordable medium 826 in a direction non-perpendicular to optically recordable medium 826, thereby providing an off-axis illumination onto surface 826-2 of optically recordable medium 826 (e.g., for an angle of diffraction having 15°, 30°, 45°, 50°, 55°, 60°, 65°, 70°, 75° or within a range between any two of the aforementioned values) while beam 832-B provides an on-axis illumination onto surface 826-1 of optically recordable medium 826 (for 0° angle of incidence). In some implementations, multi-faceted prism 816 directs at least a portion of beam 834-B onto optically recordable medium 826 in a direction non-perpendicular to optically recordable medium 826, thereby providing an off-axis illumination onto surface 826-2 of optically recordable medium 826 while beam 832-B also provides an off-axis illumination onto surface 826-1 of optically recordable medium 826.

The third set of optical elements 800-C receives beam 834-B and project the beam toward optically recordable medium 826 for forming a holographic medium. System 800 is configured to form holographic mediums described above with respect to FIGS. 4A-4B. The holographic mediums formed by formed by system 800 are configured to project configurations such as any of those described above with respect to FIGS. 5A-5D. In some embodiments, the third set of optical elements 800-C includes one or more lenses 820.

FIG. 8B is a schematic diagram illustrating a prism used for making a multi-view holographic optical element in accordance with some embodiments. The prism illustrated in FIG. 8 is an example of multi-faceted prism 816. One end of multi-faceted prism 816 includes two or more (e.g., three or more, four or more, five or more, etc.) facets for forming multiple regions (e.g., regions 412-1, 412-2, and 412-3) in optically recordable medium 826. In FIG. 8B, one end of the prism has seven facets 841 through 847 for providing a multi-view image shown in FIG. 7A. In some embodiments, one or more facets (e.g., facets 841 through 847) of the prism are non-flat facets (e.g., concave facets, convex facets, freeform facets, etc.).

In some embodiments, the prism is made of glass. In some embodiments, the prism is made of a material having a refractive index of 1.2, 1.3, 1.4, 1.5, 1.6, 1.7, 1.8, 1.9, 2.0, 2.1, or within a range between any two of the aforementioned values.

In light of these principles, we now turn to certain embodiments.

In accordance with some embodiments, a method includes projecting, with a holographic optical element, a first view of an eye toward an imaging device (e.g., portion 406-1 of light 405 corresponding to a view of eye 408 from view point 410-1 as shown in FIG. 4A); and projecting, with the holographic optical element, a second view of the eye, distinct from the first view of the eye, toward the imaging device (e.g., portion 406-2 of light 405 corresponding to a view of eye 408 from view point 410-2) so that the first view and the second view of the eye are concurrently received by the imaging device (e.g., imaging device 402 concurrently receives the first view and the second view of the eye).

In some embodiments, the first view and the second view of the eye are stored in a single image including multiple views of the eye (e.g., multi-view image shown in FIG. 7A).

In some embodiments, the method includes determining a position of the eye based on at least the first view and the second view of the eye. For example, the intensity of glints in the first view and the second view are compared to determine the position of the eye. In some embodiments, the glints in the first view and the glints in the second view are combined to provide combined glint information (e.g., to provide a position of a glint occluded in one of the views).

In some embodiments, the method includes projecting, with the holographic optical element, a third view of the eye, distinct from the first view and the second view of the eye, toward the imaging device (e.g., portion 406-3 of light 405 corresponding to a view of eye 408 from view point 410-3) so that the first view, the second view, and the third view of the eye are concurrently received by the imaging device.

In some embodiments, the method includes projecting, with the holographic optical element, at least seven views of the eye toward the imaging device, where the seven views are distinct from one another (e.g., FIG. 7A).

In some embodiments, the seven views include a central view of the eye and six peripheral views of the eye (e.g., central view 701 and peripheral views 702 through 707).

In some embodiments, the method includes receiving, on the holographic optical element, light from a light source (e.g., holographic medium 424 in FIG. 4D receives light from light source 502); and projecting, with the holographic optical element, a pattern of illumination light toward the eye (e.g., patterns 426-1, 426-2, and 426-3).

In some embodiments, the pattern of illumination light includes a plurality of spots that are distinct and separate from one another (e.g., patterns shown in FIGS. 5A-5D).

In some embodiments, the first view of the eye is projected toward a first portion of the imaging device; and the second view of the eye is projected toward a second portion, distinct from the first portion of the imaging device, of the imaging device (e.g., portion 406-1 of light 405 corresponding to a view of eye 408 from view point 410-1 is projected toward the first portion 1 of the imaging device and portion 406-2 of light corresponding to a view of eye 408 from view point 410-2 is projected toward the second portion 2 of the imaging device as shown in the inset of FIG. 4A).

In some embodiments, the method includes, while projecting the first view and the second view of the eye toward the imaging device, transmitting ambient light (e.g., ambient light 428 in FIG. 4D) through the holographic optical element toward the eye.

In some embodiments, the first view of the eye corresponds to a view of the eye taken from a first view point (e.g., view point 410-1); and the second view of the eye corresponds to a view of the eye taken from a second view point (e.g., view point 410-2) that is distinct and separate from the first view point.

In some embodiments, projecting the first view of the eye toward the imaging device and projecting the second view of the eye toward the imaging device include receiving light from the eye on a first surface of the holographic optical element and reflectively providing the light back through the first surface of the holographic optical element toward the imaging device (e.g., FIG. 4A).

In accordance with some embodiments, an eye tracking device includes an imaging device (e.g., imaging device 402); and a holographic optical element positioned relative to the imaging device for projecting a first view of a target area toward the imaging device (e.g., portion 406-1 of light 405 corresponding to a view of eye 408 from view point 410-1) and projecting a second view of the target area, distinct from the first view of the target area, toward the imaging device (e.g., portion 406-2 of light 405 corresponding to a view of eye 408 from view point 410-2) so that the first view and the second view of the target area are concurrently received by the imaging device. For example, the holographic optical element may project views of an area that may be larger or smaller than the eye (or the pupil).

In some embodiments, the first view and the second view of the eye are stored in a single image including multiple views of the eye (e.g., FIG. 7A).

In some embodiments, the eye tracking device includes one or more processors (e.g., processors 216) for determining a position of the eye based on at least the first view and the second view of the target area.

In some embodiments, the holographic optical element is positioned for projecting a third view of the target area, distinct from the first view and the second view of the target area, toward the imaging device (e.g., portion 406-3 of light 405 corresponding to a view of eye 408 from view point 410-3) so that the first view, the second view, and the third view of the target area are concurrently received by the imaging device.

In some embodiments, the holographic optical element is configured to project at least seven views of the target area toward the imaging device, each view of the seven views being distinct from one another (e.g., FIG. 7A).

In some embodiments, the eye tracking device includes a light source (e.g., light source 502) for providing light toward the holographic optical element so that the holographic optical element projects a pattern of illumination light toward the target area.

In some embodiments, the holographic optical element is configured for projecting the first view of the target area toward the imaging device with a first optical power and projecting the second view of the target area toward the imaging device with a second optical power distinct from the first optical power. For example, region 412-1 and region 412-2 have different distances to imaging device 402, and thus, in some configurations, region 412-1 has the first optical power and region 412-2 has the second optical power that is distinct from the first optical power so that both the first view of eye 408 (or the target area) and the second view of eye 408 form images on a same plane (e.g., sensor plane) on imaging device 402.

In accordance with some embodiments, a head-mounted display device includes any eye tracking device described herein (e.g., FIG. 6C).

In accordance with some embodiments, a holographic optical element configured for projecting a first view of a target area toward an imaging device and projecting a second view of the target area, distinct from the first view of the target area, toward the imaging device so that the first view and the second view of the target area are concurrently received by the imaging device.

In accordance with some embodiments, a method of making a holographic optical element includes recording a first holographic pattern in the holographic optical element by concurrently providing a first beam for a first view point and a second beam from a target area; and recording a second holographic pattern in the holographic optical element by concurrently providing a third beam for a second view point that is distinct from the first view point and the second beam from the target area (e.g., FIG. 8A).

Although various drawings illustrate operations of particular components or particular groups of components with respect to one eye, a person having ordinary skill in the art would understand that analogous operations can be performed with respect to the other eye or both eyes. For brevity, such details are not repeated herein.

Although some of various drawings illustrate a number of logical stages in a particular order, stages which are not order dependent may be reordered and other stages may be combined or broken out. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method, comprising:
projecting, with a holographic optical element, a first view of an eye toward an imaging device; and
projecting, with the holographic optical element, a second view of the eye, distinct from the first view of the eye, toward the imaging device so that the first view and the second view of the eye are concurrently received by the imaging device.

2. The method of claim 1, wherein:
the first view and the second view of the eye are stored in a single image including multiple views of the eye.

3. The method of claim 1, further comprising:
determining a position of the eye based on at least the first view and the second view of the eye.

4. The method of claim 1, further comprising:
projecting, with the holographic optical element, a third view of the eye, distinct from the first view and the second view of the eye, toward the imaging device so that the first view, the second view, and the third view of the eye are concurrently received by the imaging device.

5. The method of claim 1, including:
projecting, with the holographic optical element, at least seven views of the eye toward the imaging device, the seven views being distinct from one another.

6. The method of claim 1, further comprising:
receiving, on the holographic optical element, light from a light source; and
projecting, with the holographic optical element, a pattern of illumination light toward the eye.

7. The method of claim 1, wherein:
the first view of the eye is projected toward a first portion of the imaging device; and
the second view of the eye is projected toward a second portion, distinct from the first portion of the imaging device, of the imaging device.

8. The method of claim 1, further comprising:
while projecting the first view and the second view of the eye toward the imaging device, transmitting ambient light through the holographic optical element toward the eye.

9. The method of claim 1, wherein:
the first view of the eye corresponds to a view of the eye taken from a first view point; and
the second view of the eye corresponds to a view of the eye taken from a second view point that is distinct and separate from the first view point.

10. The method of claim 1, wherein:
projecting the first view of the eye toward the imaging device and projecting the second view of the eye toward the imaging device include receiving light from the eye on a first surface of the holographic optical element and reflectively providing the light back through the first surface of the holographic optical element toward the imaging device.

11. An eye tracking device, comprising:
an imaging device; and
a holographic optical element positioned relative to the imaging device for projecting a first view of a target area toward the imaging device and projecting a second view of the eye, distinct from the first view of the eye, toward the imaging device so that the first view and the second view of the eye are concurrently received by the imaging device.

12. The eye tracking device of claim 11, wherein:
the first view and the second view of the eye are stored in a single image including multiple views of the eye.

13. The eye tracking device of claim 11, further comprising:
one or more processors for determining a position of the eye based on at least the first view and the second view of the target area.

14. The eye tracking device of claim 11, wherein:
the holographic optical element is positioned for projecting a third view of the target area, distinct from the first view and the second view of the target area, toward the imaging device so that the first view, the second view, and the third view of the target area are concurrently received by the imaging device.

15. The eye tracking device of claim 11, wherein:
the holographic optical element is configured to project at least seven views of the target area toward the imaging device, each view of the seven views being distinct from one another.

16. The eye tracking device of claim 11, further comprising:
a light source for providing light toward the holographic optical element so that the holographic optical element projects a pattern of illumination light toward the target area.

17. The eye tracking device of claim 11, wherein:
the holographic optical element is configured for projecting the first view of the target area toward the imaging device with a first optical power and projecting the second view of the target area toward the imaging device with a second optical power distinct from the first optical power.

18. A head-mounted display device, comprising the eye tracking device of claim 11.

19. A holographic optical element configured for projecting a first view of a target area toward an imaging device and projecting a second view of the target area, distinct from the first view of the target area, toward the imaging device so that the first view and the second view of the target area are concurrently received by the imaging device.

20. A method of making the holographic optical element of claim 19, the method comprising:
recording a first holographic pattern in the holographic optical element by concurrently providing a first beam for a first view point and a second beam from a target area; and
recording a second holographic pattern in the holographic optical element by concurrently providing a third beam for a second view point that is distinct from the first view point and the second beam from the target area.
